(19) United States
(12) Patent Application Publication
(10) Pub. No.: US 2025/0183814 A1
(43) Pub. Date: Jun. 5, 2025

(54) POWER CONVERSION DEVICE

(71) Applicant: Mitsubishi Electric Corporation, Tokyo (JP)

(72) Inventors: Tetsuya KOJIMA, Tokyo (JP); Yoshihito IMAI, Tokyo (JP); Hisatoshi FUKUMOTO, Tokyo (JP)

(73) Assignee: Mitsubishi Electric Corporation, Tokyo (JP)

(21) Appl. No.: 18/844,064

(22) PCT Filed: Mar. 16, 2022
(86) PCT No.: PCT/JP2022/011849

§ 371 Date: Sep. 5, 2024

(51) Int. Cl. H02M 7/487; H02M 1/00; H02M 7/5395

(52) U.S. Cl. CPC H02M 7/487; H02M 1/0054; H02M 7/5395

(57) ABSTRACT

A power conversion device includes a neutral point clamped multilevel power converter and a control device. The control device includes a modulation voltage generator which generates modulation phase voltage commands using phase voltage commands and phase currents, and a PWM modulator which generates gate signals for driving the power converter, using the modulation phase voltage commands. The modulation voltage generator calculates offset voltage so that, for a middle phase in which a high-low rank is middle among the phase voltage commands for respective phases, a polarity of the phase voltage command does not become opposite to a polarity of the phase current, and superimposes the offset voltage as first common voltage on the phase voltage commands for respective phases, to generate the modulation phase voltage commands.

### TECHNICAL FIELD

The present disclosure relates to a power conversion device.

### BACKGROUND ART

One example of a circuit for converting high-output DC power to AC power is a multilevel inverter of a neutral point clamped type.

In a conventional power conversion device, using pulse width modulation (PWM) control, a control device compares a voltage command value for each of three phases of a three-phase N-level inverter (N is an odd number not less than 3) which is a main circuit, with (N−1) carrier signals, to generate switching signals for switching elements of the N-level inverter.

The control device of the multilevel inverter described in Patent Document 1 includes: a maximum current phase selection unit which selects a maximum current phase in which the current amplitude is greatest, on the basis of the absolute values of current detection values or current command values for the respective three phases; a subtraction unit which subtracts the voltage command value for the selected maximum current phase from the voltage command value for each of the three phases of the N-level inverter; and a carrier comparator 55 which compares the voltage command value for each of the three phases after the subtraction, with the (N−1) carrier signals, to generate switching signals for the switching elements of the N-level inverter.

### CITATION LIST

### Patent Document

Patent Document 1: Japanese Laid-Open Patent Publication No. 2019-30070

### SUMMARY OF THE INVENTION

### Problem to be Solved by the Invention

In a three-level neutral point clamped (NPC) inverter, it is known that loss and heat generation are great in a switching element connected on the AC terminal side. In the conventional technology described in Patent Document 1, switching loss for the maximum current phase is reduced so that loss in the entire power conversion device is reduced, but loss in the switching element connected on the AC terminal side cannot be effectively reduced. Therefore, unevenness of loss among a plurality of switching elements in each phase of the power conversion device cannot be suppressed, so that there has been a limitation in improving conversion efficiency and output.

The present disclosure has been made to solve the above problem, and an object of the present disclosure is to provide a power conversion device of a neutral point clamped type in which loss in a semiconductor switching element connected on the AC terminal side is effectively reduced and unevenness of loss among a plurality of switching elements in each phase is suppressed, thus achieving high output and high efficiency.

### Means to Solve the Problem

A power conversion device according to the present disclosure includes: a multilevel power converter of a neutral point clamped type, which performs power conversion between DC power and AC power; and a control device which performs output control for the power converter through PWM control. The power converter has a multiphase configuration that includes, in each phase of the power converter, an upper arm and a lower arm each formed by connecting a first switching element on a DC terminal side and a second switching element on an AC terminal side in series to each other, and a clamp diode connected between a neutral point and a connection point between the first and second switching elements. The control device includes a modulation voltage generator which generates modulation phase voltage commands on the basis of phase voltage commands and phase currents, and a PWM modulator which generates gate signals for driving the first and second switching elements of the power converter, on the basis of the modulation phase voltage commands. The modulation voltage generator calculates offset voltage so that, for a middle phase in which a high-low rank is middle among the phase voltage commands for the respective phases, a polarity of the phase voltage command does not become opposite to a polarity of the phase current, and superimposes the offset voltage as first common voltage on the phase voltage commands for the respective phases, to generate the modulation phase voltage commands.

### Effect of the Invention

The power conversion device according to the present disclosure makes it possible to provide a power conversion device in which loss in a second switching element connected on the AC terminal side can be effectively reduced and unevenness of loss among a plurality of switching elements in each phase is suppressed, thus achieving high output and high efficiency.

### BRIEF DESCRIPTION OF THE DRAWINGS

FIG. 1 is a configuration diagram showing a power conversion device according to embodiment 1.

FIG. 2 is a current route diagram illustrating basic operation of the power conversion device according to embodiment 1.

FIG. 3 is a current route diagram illustrating basic operation of the power conversion device according to embodiment 1.

FIG. 4 is a flowchart illustrating operation of a modulation voltage generator according to embodiment 1.

FIG. 5 is waveform diagrams illustrating operation of a PWM modulator according to embodiment 1.

FIG. 6 is waveform diagrams illustrating operation of the PWM modulator according to embodiment 1.

FIG. 7 is waveform diagrams illustrating operation of a power conversion device in a comparative example of embodiment 1.

FIG. 8 is waveform diagrams illustrating operation of the power conversion device according to embodiment 1.

FIG. 9 is a configuration diagram showing a power conversion device according to embodiment 2.

FIG. 10 is a flowchart illustrating operation of a modulation voltage corrector according to embodiment 2.

FIG. 11 is waveform diagrams illustrating operation of the power conversion device according to embodiment 2.

FIG. 12 is a configuration diagram showing a power conversion device according to embodiment 3.

FIG. 13 is a configuration diagram showing an example of hardware for implementing functions of a control device according to any of embodiments 1 to 3.

FIG. 14 is a configuration diagram showing another example of hardware for implementing functions of the control device according to any of embodiments 1 to 3.

### DESCRIPTION OF EMBODIMENTS

### Embodiment 1

Hereinafter, embodiments will be described with reference to the drawings.

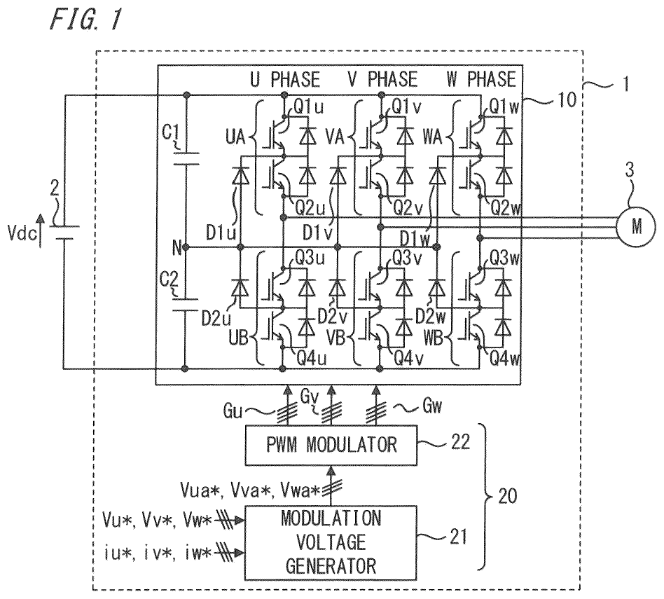

FIG. 1 is a configuration diagram showing a power conversion device according to embodiment 1.

As shown in FIG. 1, a power conversion device 1 is, for example, connected between a DC power supply 2 and a motor which is a load 3, and converts DC power of the DC power supply 2 to AC power, to supply the AC power to the load 3.

The power conversion device 1 may be capable of bidirectional operation and may convert regenerative power from the load 3 to DC power, to charge the DC power supply 2.

The power conversion device 1 includes an NPC inverter 10 as a three-phase three-level power converter, and a control device 20 which performs output control for the NPC inverter 10 through PWM control.

The NPC inverter 10 includes two capacitors C1, C2 connected in series between DC buses, and upper and lower arms (UA, UB), (VA, VB), (WA, WB) for each phase (U phase, V phase, W phase) which are connected in series to each other, and further includes clamp diodes (D1u, D2u), (D1v, D2v), (D1w, D2w) for each phase. A connection point between the two capacitors C1, C2 is a neutral point N, and connection points between the upper and lower arms (UA, UB), (VA, VB), (WA, WB) for the respective phases are AC terminals for the respective phases.

The upper arm UA for U phase is formed by connecting, in series, a switching element Q1u as a first switching element on the DC terminal side and a switching element Q2u as a second switching element on the AC terminal side. The lower arm UB for U phase is formed by connecting, in series, a switching element Q4u as a first switching element on the DC terminal side and a switching element Q3u as a second switching element on the AC terminal side. The clamp diode D1u is connected between the neutral point N and a connection point between the switching element Q1u and the switching element Q2u. The clamp diode D2u is connected between the neutral point N and a connection point between the switching element Q4u and the switching element Q3u.

The upper arm VA for V phase is formed by connecting, in series, a switching element Q1v as a first switching element on the DC terminal side and a switching element Q2v as a second switching element on the AC terminal side. The lower arm VB for V phase is formed by connecting, in series, a switching element Q4v as a first switching element on the DC terminal side and a switching element Q3v as a second switching element on the AC terminal side. The clamp diode D1v is connected between the neutral point N and a connection point between the switching element Q1v and the switching element Q2v. The clamp diode D2v is connected between the neutral point N and a connection point between the switching element Q4v and the switching element Q3v.

The upper arm WA for W phase is formed by connecting, in series, a switching element Q1w as a first switching element on the DC terminal side and a switching element Q2w as a second switching element on the AC terminal side. The lower arm WB for W phase is formed by connecting, in series, a switching element Q4w as a first switching element on the DC terminal side and a switching element Q3w as a second switching element on the AC terminal side. The clamp diode D1w is connected between the neutral point N and a connection point between the switching element Q1w and the switching element Q2w. The clamp diode D2w is connected between the neutral point N and a connection point between the switching element Q4w and the switching element Q3w.

The first switching elements (switching elements Q1u, Q1v, Q1w) in the upper arms UA, VA, WA for the respective phases are connected to a DC terminal on the high-voltage side, and the second switching elements (switching elements Q2u, Q2v, Q2w) are connected to AC terminals for the respective phases. The first switching elements (switching elements Q4u, Q4v, Q4w) in the lower arms UB, VB, WB for the respective phases are connected to a DC terminal on the low-voltage side, and the second switching elements (switching elements Q3u, Q3v, Q3w) are connected to the AC terminals for the respective phases. The clamp diodes D1u, D1v, D1w connected to the upper arms UA, VA, WA have anodes connected to the neutral point N. The clamp diodes D2u, D2v, D2w connected to the lower arms UB, VB, WB have cathodes connected to the neutral point N.

The switching elements Q1u to Q4u, Q1v to Q4v, Q1w to Q4w are, for example, semiconductor switching elements made of silicon, and may be insulated gate bipolar transistors (IGBT) to which a diode is connected in antiparallel, metal oxide semiconductor field effect transistors (MOSFET) with a diode connected between the source and the drain, and the like. In a case of a MOSFET or a reverse conducting (RC) IGBT, diodes included in the switching elements Q1u to Q4u, Q1v to Q4v, Q1w to Q4w may be used.

The control device 20 includes a modulation voltage generator 21 which generates modulation phase voltage commands Vua*, Vva*, Vwa* for the respective phases, and a PWM modulator 22 which generates gate signals Gu, Gv, Gw for driving the switching elements Q1u to Q4u, Q1v to Q4v, Q1w to Q4w for the respective phases, on the basis of the modulation phase voltage commands Vua*, Vva*, Vwa*.

The modulation voltage generator 21 receives phase voltage commands Vu*, Vv*, Vw* and phase current commands iu*, iv*, iw* for the respective phases, and generates the modulation phase voltage commands Vua*, Vva*, Vwa* through calculation described later. In this case, the phase voltage commands Vu*, Vv*, Vw* for the respective phases have sinusoidal voltage waveforms.

Currents flowing through the load 3 when voltages according to provided phase voltage commands Vu*, Vv*, Vw* are supplied to the load 3 may be calculated using a model of the load 3, or the like, and the calculated currents may be used as the phase current commands iu*, iv*, iw*.

The phase voltage commands Vu*, Vv*, Vw* may be acquired by performing control or calculation so that currents flowing through the load 3 have the values of provided phase current commands iu*, iv*, iw*.

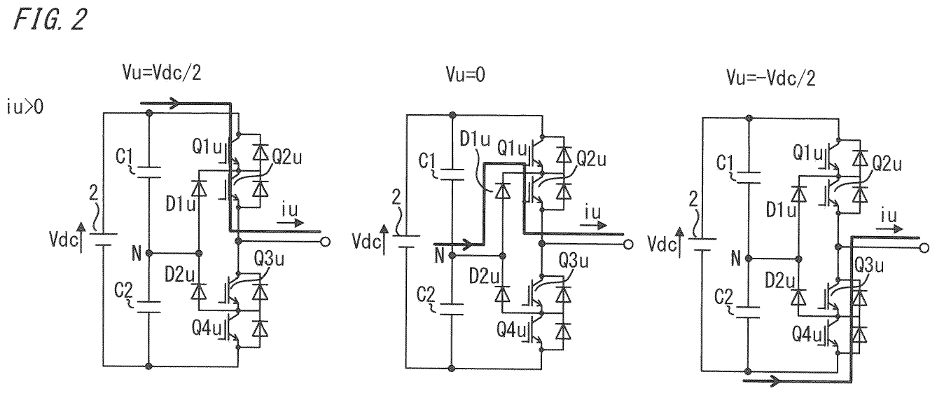

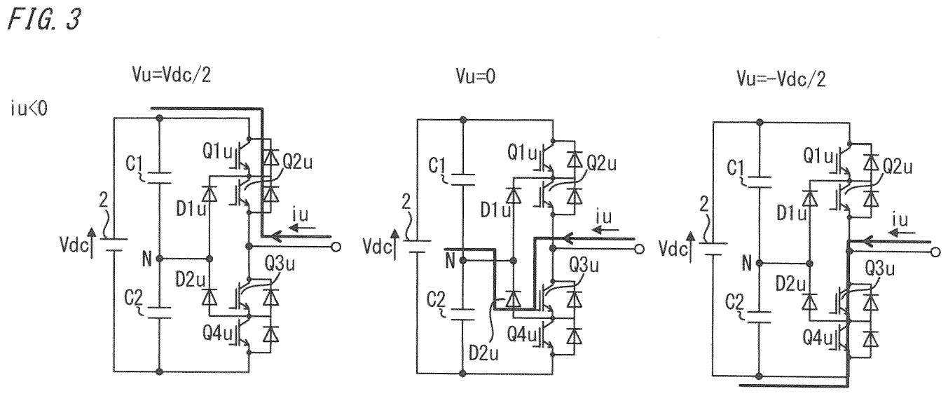

FIG. 2 and FIG. 3 are current route diagrams illustrating basic operation of the power conversion device 1.

The relationship between output voltage for each phase of the NPC inverter 10 and a current route will be described below, with reference to the drawings. In this case, description will be given for U phase as an example, but the same applies to V phase and W phase.

In this case, phase voltage Vu is voltage with respect to the neutral point N as a reference, and phase current iu is defined such that a direction of flow from the NPC inverter 10 to the load 3 is positive. FIG. 2 shows a case where the phase current iu is positive, and FIG. 3 shows a case where the phase current iu is negative.

In U phase of the NPC inverter 10, the phase voltage Vu is outputted at three levels which are positive, negative, and 0 and with a magnitude that is ½ of the voltage Vdc of the DC power supply 2 with respect to the neutral point N as a reference.

As shown in FIG. 2, in a case where the phase current iu is positive, when the phase voltage Vu is outputted at (Vdc/2), the switching elements Q1u, Q2u of the upper arm QA conduct current, and when the phase voltage Vu is 0, only the switching element Q2u of the upper arm QA conducts current. In a case where the phase current iu is positive, when the phase voltage Vu is outputted at −(Vdc/2), the switching elements Q4u, Q3u (in a case of FIG. 2, antiparallel diodes) of the lower arm QB conduct current.

In PWM control, the phase voltage Vu is switched alternately between two switching states of (Vdc/2) and 0, whereby the phase voltage Vu that is positive on average is outputted.

Therefore, in a case where the polarity of the phase current iu is positive, if the polarity of the phase voltage Vu is positive or 0, the switching element Q2u which is the second switching element may continue being in a conductive state and only the switching element Q1u which is the first switching element may perform ON/OFF switching. That is, the switching element Q2u which is the second switching element can be kept in an ON state, so that switching thereof can be omitted.

As shown in FIG. 3, in a case where the phase current iu is negative, when the phase voltage Vu is outputted at (Vdc/2), the switching elements Q1u, Q2u (in a case of FIG. 3, antiparallel diodes) of the upper arm QA conduct current. In a case where the phase current iu is negative, when the phase voltage Vu is 0, only the switching element Q3u of the lower arm QB conducts current, and when the phase voltage Vu is outputted at −(Vdc/2), the switching elements Q4u, Q3u of the lower arm QB conduct current.

In PWM control, the phase voltage Vu is switched alternately between two switching states of −(Vdc/2) and 0, whereby the phase voltage Vu that is negative on average is outputted.

Therefore, in a case where the polarity of the phase current iu is negative, if the polarity of the phase voltage Vu is negative or 0, the switching element Q3u which is the second switching element may continue being in a conductive state and only the switching element Q4u which is the first switching element may perform ON/OFF switching. That is, the switching element Q3u which is the second switching element can be kept in an ON state, so that switching thereof can be omitted.

As described above, if the polarity of the phase voltage Vu matches the polarity of the phase current iu or is 0, i.e., if both polarities are not opposite to each other, the second switching element (switching element Q2u or Q3u) can be kept in an ON state, so that switching thereof can be omitted.

Next, operation of the modulation voltage generator 21 will be described. The modulation voltage generator 21 receives the phase voltage commands Vu*, Vv*, Vw* and the phase current commands iu*, iv*, iw* for the respective phases, and generates the modulation phase voltage commands Vua*, Vva*, Vwa*.

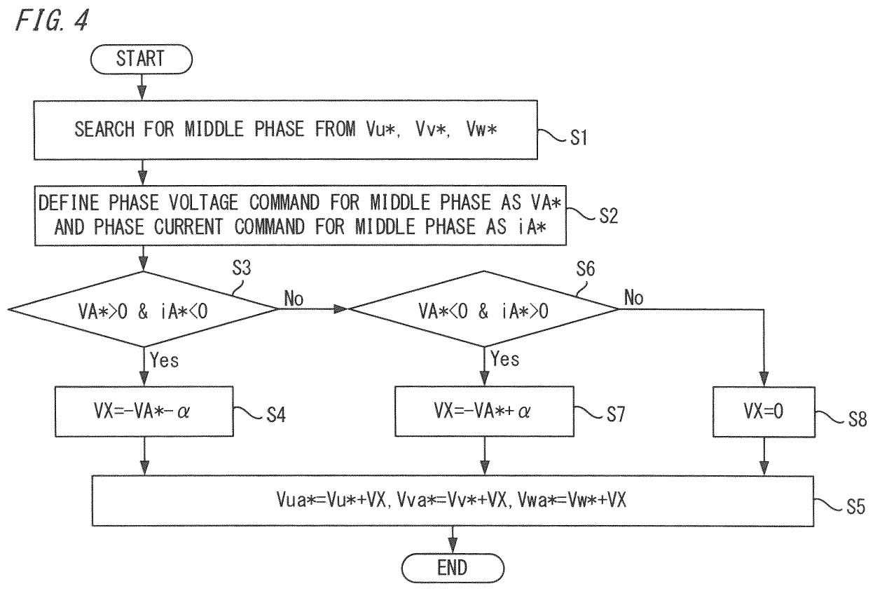

FIG. 4 is a flowchart illustrating operation of the modulation voltage generator 21.

The modulation voltage generator 21 generates the modulation phase voltage commands Vua*, Vva*, Vwa* on the basis of the phase voltage commands Vu*, Vv*, Vw* and the phase current commands iu*, iv*, iw* for the respective phases, in every predetermined calculation cycle.

First, the modulation voltage generator 21 searches for a middle phase in which the high-low rank is middle among the phase voltage commands Vu*, Vv*, Vw* for the respective phases (step S1), and defines the phase voltage command for the middle phase as VA* and the phase current command for the middle phase as iA* (step S2).

For example, in a period in which Vw*<Vu*<Vv* is satisfied, U phase is the middle phase, so that the phase voltage command Vu* for U phase is defined as VA* and the phase current command iu* for U phase is defined as iA*.

Next, the modulation voltage generator 21 determines whether or not VA* is positive and iA* is negative (step S3), and in a case of Yes, the modulation voltage generator 21 sets offset voltage VX as VX=−VA*−α (step S4). Here, a is a constant voltage value that is positive or 0.

Next, the modulation voltage generator 21 superimposes the offset voltage VX as first common voltage on the phase voltage commands Vux, Vv*, Vw* for the respective phases, to generate the modulation phase voltage commands Vua*, Vva*, Vwa*. That is, Vua*=Vu*+VX, Vva*=Vv*+VX, and Vwa*=Vw*+VX are satisfied (step S5).

In step S3, in a case of No, the modulation voltage generator 21 determines whether or not VA* is negative and iA* is positive (step S6), and if the determination result is Yes, the modulation voltage generator 21 sets offset voltage VX as VX=−VA*+α (step S7), and then proceeds to step S5. In a case of No in step S6, the modulation voltage generator 21 sets offset voltage VX as VX=0 (step S8), and then proceeds to step S5.

As described above, the modulation voltage generator 21 calculates the offset voltage VX so that, for the middle phase in which the high-low rank is middle among the phase voltage commands Vux, Vv*, Vw* for the respective phases, the polarity of the phase voltage command VA* does not become opposite to the polarity of the phase current command iA*. Specifically, the modulation voltage generator 21 calculates the offset voltage VX so that, for the middle phase, in a period in which the polarity of the phase voltage command VA* is positive and the polarity of the phase current command iA* is negative, the value of the phase voltage command VA* does not become greater than 0. In addition, the modulation voltage generator 21 calculates the offset voltage VX so that, in a period in which the polarity of the phase voltage command VA* is negative and the polarity of the phase current command iA* is positive, the value of the phase voltage command VA* does not become smaller than 0.

The offset voltage VX is set so as not to be greater than necessary, and α is set at 0 or a comparatively small positive voltage value in consideration of a margin.

The modulation voltage generator 21 superimposes the offset voltage VX as the first common voltage on the phase voltage commands Vu*, Vv*, Vw* for the respective phases, to generate the modulation phase voltage commands Vua*, Vva*, Vwa*.

Next, operation of the PWM modulator 22 will be described. The PWM modulator 22 generates the gate signals Gu, Gv, Gw for driving the switching elements Q1u to Q4u, Q1v to Q4v, Q1w to Q4w for the respective phases, on the basis of the modulation phase voltage commands Vua*, Vva*, Vwa*.

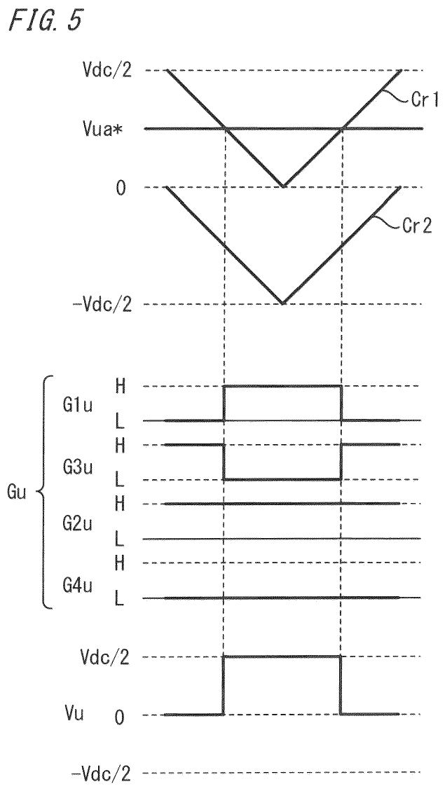

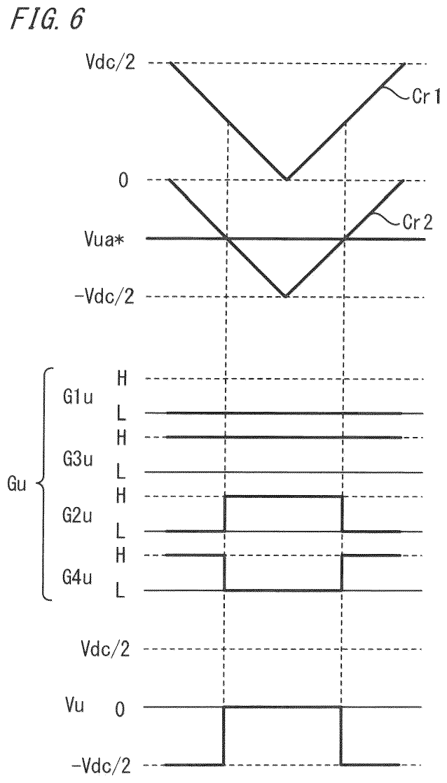

FIG. 5 and FIG. 6 are waveform diagrams illustrating operation of the PWM modulator 22.

Also in this case, description will be given for U phase as an example, but the same applies to V phase and W phase. FIG. 5 shows a case where the modulation phase voltage command Vua* satisfies Vua*≥0, and FIG. 6 shows a case where the modulation phase voltage command Vua* satisfies Vua*<0. The gate signals Gu collectively represent gate signals G1u, G2u, G3u, G4u for the switching elements Q1u, Q2u, Q3u, Q4u for U phase.

The PWM modulator 22 compares the modulation phase voltage command Vua* with two carrier waves, i.e., triangular waves Cr1, Cr2, to generate the gate signals Gu. The triangular wave Cr1 changes in a range of zero to (Vdc/2), and the triangular wave Cr2 changes in a range of −(Vdc/2) to zero.

In the NPC inverter 10, the switching element Q1u and the switching element Q3u are driven by the gate signal G1u and the gate signal G3u inverted from each other between H and L. In addition, the switching element Q2u and the switching element Q4u are driven by the gate signal G2u and the gate signal G4u inverted from each other between H and L.

As shown in FIG. 5, in a case of the modulation phase voltage command Vua*≥0, the gate signal G2u is kept at H and the gate signal G4u is kept at L. In a region where the modulation phase voltage command Vua* becomes greater than the triangular wave Cr1, the gate signal G1u becomes H and the gate signal G3u becomes L. At this time, the phase voltage Vu is outputted at (Vdc/2). In a region where the modulation phase voltage command Vua* is not greater than the triangular wave Cr1, the gate signal G1u becomes L and the gate signal G3u becomes H. At this time, the phase voltage Vu is outputted at 0.

Thus, the average value of the phase voltage Vu satisfies the modulation phase voltage command Vua* through PWM control.

As shown in FIG. 6, in a case of the modulation phase voltage command Vua*<0, the gate signal G1u is kept at L and the gate signal G3u is kept at H. In a region where the modulation phase voltage command Vua* becomes greater than the triangular wave Cr1, the gate signal G2u becomes H and the gate signal G4u becomes L. At this time, the phase voltage Vu is outputted at 0. In a region where the modulation phase voltage command Vua* is not greater than the triangular wave Cr2, the gate signal G2u becomes L and the gate signal G4u becomes H. At this time, the phase voltage Vu is outputted at −(Vdc/2).

Thus, the average value of the phase voltage Vu satisfies the modulation phase voltage command Vua* through the PWM control.

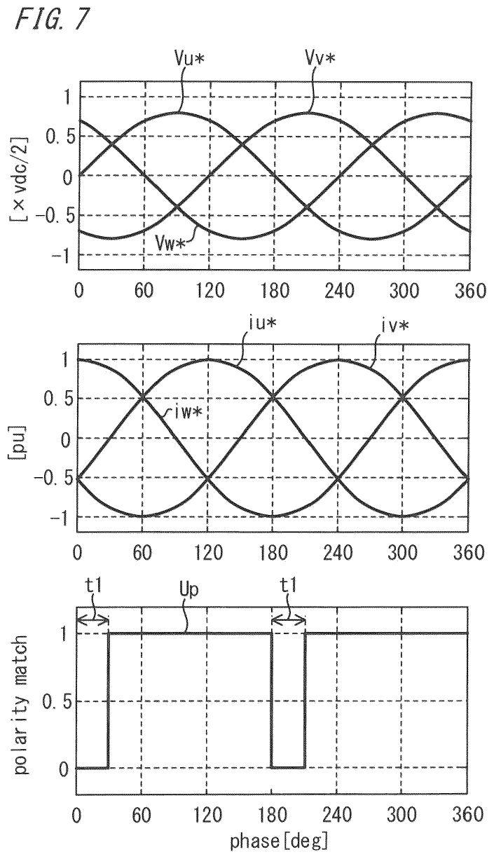

FIG. 7 is waveform diagrams illustrating operation of the power conversion device in a comparative example of the present embodiment.

In the comparative example, the modulation voltage generator 21 is not provided, that is, the phase voltage commands Vu*, Vv*, Vw* for the respective phases are used as they are, to generate the gate signals Gu. In FIG. 7, the phase voltage commands Vu*, Vv*, Vw* and the phase current commands iu*, iv*, iw* for the respective phases are shown, and for U phase, a waveform Up indicating whether the polarities of the phase voltage command Vu* and the phase current command iu* match each other or are opposite to each other, is shown. In a case of the phase voltage command Vu*=0, Up is considered as 1, which indicates that the polarities match each other.

As shown in the waveform Up, a section t1 where the polarities of the phase voltage command Vu* and the phase current command iu* are opposite to each other without matching each other is present in a region where U phase is the middle phase.

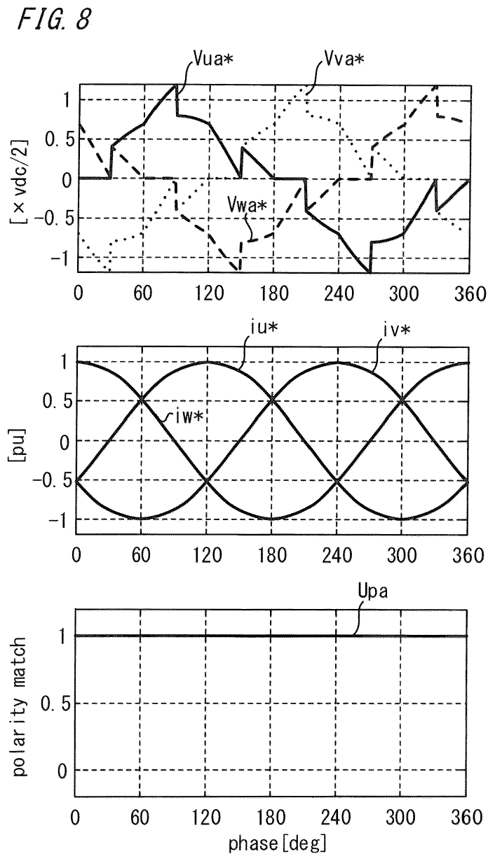

FIG. 8 is waveform diagrams illustrating operation of the power conversion device according to the present embodiment 1.

In the present embodiment, as described above, the modulation voltage generator 21 calculates the offset voltage VX so that, for the middle phase, the polarity of the phase voltage command VA* does not become opposite to the polarity of the phase current command iA*. In this case, the offset voltage VX is calculated with a set at 0.

Then, the modulation voltage generator 21 superimposes the offset voltage VX as the first common voltage on the phase voltage commands Vux, Vv*, Vw* for the respective phases, to generate the modulation phase voltage commands Vua*, Vva*, Vwa*.

In FIG. 8, the modulation phase voltage commands Vua*, Vva*, Vwa* and the phase current commands iu*, iv*, iw* for the respective phases are shown, and for U phase, a waveform Upa indicating whether or not the polarities of the modulation phase voltage command Vua* and the phase current command iu* match each other, is shown.

In a case of the modulation phase voltage command Vua*=0, Upa is considered as 1, which indicates that the polarities match each other. That is, Upa is considered as 1, as long as the polarity of the modulation phase voltage command Vua* does not become opposite to the polarity of the phase current command iu*.

The modulation phase voltage commands Vua*, Vva*, Vwa* for the respective phases are generated by superimposing the same first common voltage (offset voltage VX) on the phase voltage commands Vu*, Vv*, Vw* having sinusoidal voltage waveforms. Thus, line voltages among the modulation phase voltage commands Vua*, Vva*, Vwa* for the respective phases are kept as voltages having sinusoidal waveforms, and the load 3 is not influenced.

As shown in FIG. 8, in a period in which the modulation phase voltage command Vua* corresponds to the middle phase, the offset voltage VX which is the first common voltage is superimposed so that the polarity of the modulation phase voltage command Vua* does not become opposite to the polarity of the phase current command iu*. That is, in a section corresponding to the section t1 in FIG. 7, the offset voltage VX is superimposed, so that, in a case of the phase current command iu*>0, the modulation phase voltage command Vua* becomes α, and in a case of the phase current command iu*<0, the modulation phase voltage command Vua* becomes −α. In this case, since α is 0, the modulation phase voltage command Vua* is 0 in the section corresponding to the section t1 in FIG. 7.

Thus, as shown in the waveform Upa, the polarity of the modulation phase voltage command Vua* always matches the polarity of the phase current command iu* or becomes 0, without becoming opposite. This feature applies also to V phase and W phase, that is, the polarities of the modulation phase voltage commands Vua*, Vva*, Vwa* for the respective phases always match the polarities of the phase current commands iu*, iv*, iw* for the respective phases or become 0, without becoming opposite.

As described above, for example, in U phase, if the polarity of the phase voltage Vu matches the polarity of the phase current iu or is 0, i.e., both polarities do not become opposite to each other, the second switching element (switching element Q2u or Q3u) can be kept in an ON state, so that switching thereof can be omitted.

In the present embodiment, the polarities of the modulation phase voltage commands Vua*, Vva*, Vwa* for the respective phases do not become opposite to the polarities of the phase current commands iu*, iv*, iw* for the respective phases. Thus, the numbers of times of switching of the second switching elements (Q2u, Q3u), (Q2v, Q3v), (Q2w, Q3w) connected to the AC terminals for the respective phases can be significantly decreased, whereby switching loss can be significantly reduced.

In the above description, it has been described that, in the three-level NPC inverter, loss and heat generation are great in the switching element connected on the AC terminal side. However, in the present embodiment, loss in the second switching elements (Q2u, Q3u), (Q2v, Q3v), (Q2w, Q3w) connected to the AC terminals can be effectively reduced.

As described above, in the present embodiment, the power conversion device 1 includes the NPC inverter 10 and the control device 20 which performs output control for the NPC inverter 10 through PWM control. The control device 20 includes the modulation voltage generator 21 which generates the modulation phase voltage commands Vua*, Vva*, Vwa* on the basis of the phase voltage commands Vu*, Vv*, Vw* and the phase current commands iu*, iv*, iw*, and the PWM modulator 22 which generates the gate signals Gu, Gv, Gw for driving the first and second switching elements Q1u to Q4u, Q1v to Q4v, Q1w to Q4w of the NPC inverter 10, on the basis of the modulation phase voltage commands Vua*, Vva*, Vwa*. Then, the modulation voltage generator 21 calculates the offset voltage VX so that, for the middle phase in which the high-low rank is middle among the phase voltage commands Vux, Vvx, Vw* for the respective phases, the polarity of the phase voltage command VA* does not become opposite to the polarity of the phase current command iA*, and superimposes the offset voltage VX as the first common voltage on the phase voltage commands Vu*, Vv*, Vw* for the respective phases, to generate the modulation phase voltage commands Vua*, Vva*, Vwa*.

Thus, loss in the second switching elements (Q2u, Q3u), (Q2v, Q3v), (Q2w, Q3w) connected to the AC terminals can be effectively reduced. Therefore, unevenness of loss among a plurality of switching elements for the respective phases of the NPC inverter 10 can be suppressed, thus obtaining the power conversion device 1 having high output and high efficiency.

In the present embodiment, the phase voltage commands Vu*, Vv*, Vw* are voltage commands having sinusoidal waveforms, and the modulation voltage generator 21 calculates the offset voltage VX so that, for the middle phase, the value of the phase voltage command VA* in a period in which the polarity of the phase voltage command VA* is positive and the polarity of the phase current command iA* is negative does not become greater than 0, and the value of the phase voltage command VA* in a period in which the polarity of the phase voltage command VA* is negative and the polarity of the phase current command iA* is positive does not become smaller than 0.

Thus, the modulation phase voltage commands Vua*, Vva*, Vwa* for the respective phases can be assuredly generated while the polarities thereof are always prevented from becoming opposite to the polarities of the phase current commands iu*, iv*, iw*, whereby a loss reduction effect for the second switching elements (Q2u, Q3u), (Q2v, Q3v), (Q2w, Q3w) is assuredly obtained.

In the above embodiment, the modulation phase voltage commands Vua*, Vva*, Vwa* are generated on the basis of the phase voltage commands Vu*, Vv*, Vw* and the phase current commands iu*, iv*, iw*. However, instead of the phase current commands iu*, iv*, iw*, phase currents iu, iv, iw for the respective phases may be detected and used, whereby the same effects can be obtained.

### Embodiment 2

In the above embodiment 1, the magnitudes of the modulation phase voltage commands Vua*, Vva*, Vwa* can become greater than (Vdc/2) which is ½ of the voltage Vdc of the DC power supply 2. In the present embodiment 2, the magnitudes of the modulation phase voltage commands Vua*, Vva*, Vwa* are always reduced to (Vdc/2) or less.

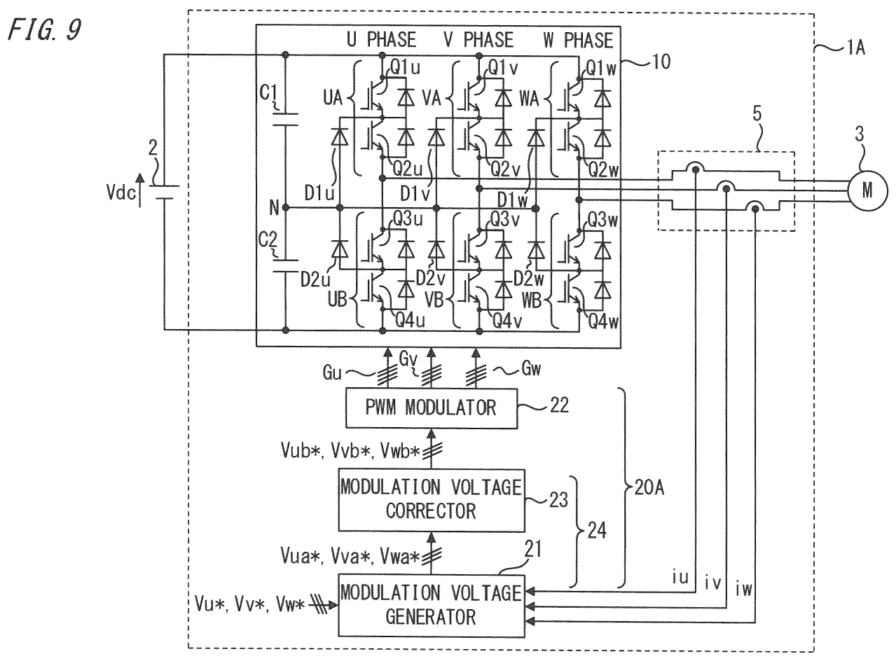

FIG. 9 is a configuration diagram showing a power conversion device according to embodiment 2.

As shown in FIG. 9, a power conversion device 1A includes the NPC inverter 10 as a three-phase three-level power converter, and a control device 20A which performs output control for the NPC inverter 10 through PWM control. The power conversion device 1A is, for example, connected between the DC power supply 2 and the motor which is the load 3, and converts DC power of the DC power supply 2 to AC power, to supply the AC power to the load 3. In this case, the NPC inverter 10 has the same configuration as that in the above embodiment 1, but the power conversion device 1A includes a current detector 5 which detects phase currents iu, iv, iw for the respective phases to be outputted from the NPC inverter 10 to the load 3.

Here, a case where the current detector 5 detects currents for the three phases is shown. However, currents for two of the three phases may be detected and current for the other one phase may be calculated from the fact that the sum of currents for the three phases is zero.

The control device 20A includes a modulation voltage generator 24 (hereinafter, referred to as second modulation voltage generator 24) which generates modulation phase voltage commands Vub*, Vvb*, Vwb* for the respective phases, and the PWM modulator 22 which generates gate signals Gu, Gv, Gw for driving the switching elements Q1u to Q4u, Q1v to Q4v, Q1w to Q4w for the respective phases, on the basis of the modulation phase voltage commands Vub*, Vvb*, Vwb*.

The second modulation voltage generator 24 generates the modulation phase voltage commands Vub*, Vvb*, Vwb* on the basis of the phase voltage commands Vux, Vv*, Vwx and the detected phase currents iu, iv, iw for the respective phases, in every predetermined calculation cycle.

The second modulation voltage generator 24 includes the same modulation voltage generator 21 as in the above embodiment 1, and a modulation voltage corrector 23 which corrects the modulation phase voltage commands Vua*, Vva*, Vwa* generated by the modulation voltage generator 21, to generate the modulation phase voltage commands Vub*, Vvb*, Vwb*.

The PWM modulator 22 receives the corrected modulation phase voltage commands Vub*, Vvb*, Vwb* and generates the gate signals Gu, Gv, Gw through the same processing as in the above embodiment 1.

In this case, the modulation voltage generator 21 receives the phase voltage commands Vux, Vv*, Vw* and the detected phase currents iu, iv, iw for the respective phases, and generates the modulation phase voltage commands Vua*, Vva*, Vwa* through the same calculation as in the above embodiment 1.

The modulation voltage generator 21 calculates the offset voltage VX so that, for the middle phase in which the high-low rank is middle among the phase voltage commands Vu*, Vv*, Vw* for the respective phases, the polarity of the phase voltage command VA* does not become opposite to the polarity of phase current iA. Specifically, the modulation voltage generator 21 calculates the offset voltage VX so that, for the middle phase, in a period in which the polarity of the phase voltage command VA* is positive and the polarity of the phase current iA is negative, the value of the phase voltage command VA* does not become greater than 0. In addition, the modulation voltage generator 21 calculates the offset voltage VX so that, in a period in which the polarity of the phase voltage command VA* is negative and the polarity of the phase current iA is positive, the value of the phase voltage command VA* does not become smaller than 0.

Then, the modulation voltage generator 21 superimposes the offset voltage VX as the first common voltage on the phase voltage commands Vux, Vv*, Vw* for the respective phases, to generate the modulation phase voltage commands Vua*, Vva*, Vwa*.

The magnitudes of the generated modulation phase voltage commands Vua*, Vva*, Vwa* can become greater than (Vdc/2) which is ½ of the voltage Vdc of the DC power supply 2 (see FIG. 8).

Next, operation of the modulation voltage corrector 23 will be described.

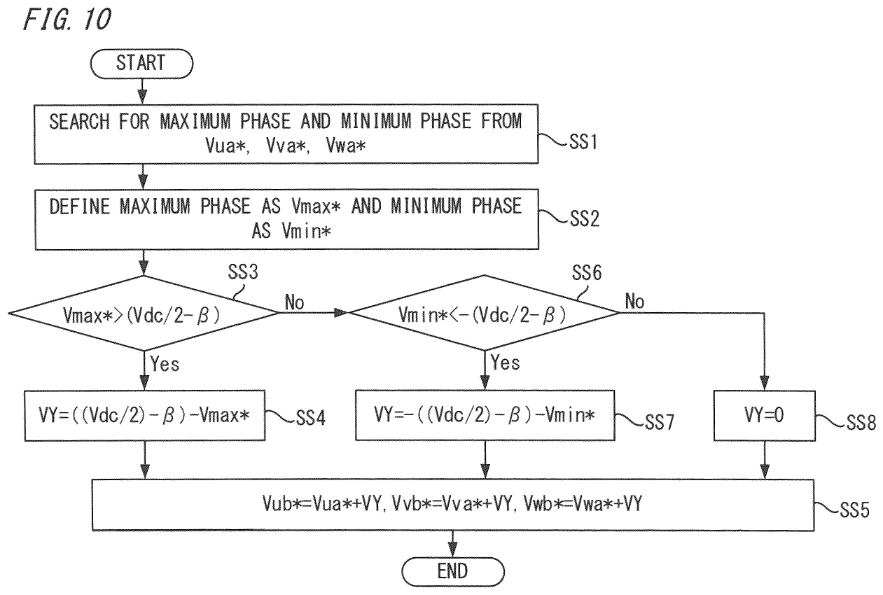

FIG. 10 is a flowchart illustrating operation of the modulation voltage corrector 23.

First, the modulation voltage corrector 23 searches for a maximum phase and a minimum phase in which the high-low ranks among the modulation phase voltage commands Vua*, Vvax, Vwa* for the respective phases are highest and lowest, respectively (step SS1), and defines the modulation phase voltage command for the maximum phase as Vmax* and the modulation phase voltage command for the minimum phase as Vmin* (step SS2).

For example, in a period in which Vwa*<Vua*<Vva* is satisfied, V phase is the maximum phase, so that Vva* is defined as Vmax*, and W phase is the minimum phase, so that Vwa* is defined as Vmin*.

Next, the modulation voltage corrector 23 determines whether or not Vmax*> (Vdc/2)−β is satisfied (step SS3), and in a case of Yes, the modulation voltage corrector 23 sets offset voltage VY which is correction voltage, as VY=((Vdc/2)−β)−Vmax* (step SS4). Here, β is a constant voltage value that is positive or 0, and ((Vdc/2)−β) is set voltage based on the voltage Vdc of the DC power supply 2.

Next, the modulation voltage corrector 23 superimposes the offset voltage VY as second common voltage on the modulation phase voltage commands Vua*, Vva*, Vwa* for the respective phases, to generate the corrected modulation phase voltage commands Vub*, Vvb*, Vwb*. That is, Vub*=Vua*+VY, Vvb*=Vva*+VY, and Vwb*=Vwa*+VY are satisfied (step SS5).

In a case of No in step SS3, the modulation voltage corrector 23 determines whether or not Vmin*<−((Vdc/2)−B) is satisfied (step SS6), and in a case of Yes, the modulation voltage corrector 23 sets the offset voltage VY which is correction voltage, as VY=−((Vdc/2)−β)−Vmin* (step SS7), and then proceeds to step S5.

In a case of No in step SS6, the modulation voltage corrector 23 sets the offset voltage VY as VY=0 (step SS8), and then proceeds to step SS5.

As described above, the modulation voltage corrector 23 calculates the offset voltage (correction voltage) VY so that the modulation phase voltage command Vmax* for the maximum phase in which the high-low rank is highest among the modulation phase voltage commands Vua*, Vva*, Vwa* for the respective phases does not become greater than the set voltage ((Vdc/2)−β), and the magnitude (absolute value) of the modulation phase voltage command Vmin* for the minimum phase in which the high-low rank is lowest does not become greater than the set voltage ((Vdc/2)−β).

The offset voltage VY is set so as not to be greater than necessary, and β is set at 0 or a comparatively small positive voltage value in consideration of a margin.

The modulation voltage corrector 23 superimposes the offset voltage VY as the second common voltage on the modulation phase voltage commands Vua*, Vva*, Vwa* for the respective phases, to generate the corrected modulation phase voltage commands Vub*, Vvb*, Vwb*.

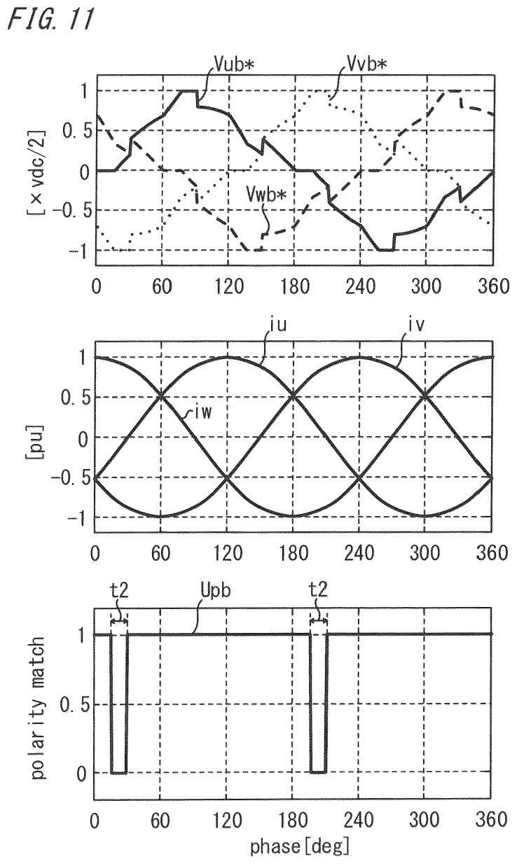

FIG. 11 is waveform diagrams illustrating operation of the power conversion device according to the present embodiment 2.

In the present embodiment, the modulation voltage generator 21 generates the modulation phase voltage commands Vua*, Vva*, Vwa* as in the above embodiment 1, and further, the modulation voltage corrector 23 corrects the modulation phase voltage commands Vua*, Vva*, Vwa*, to generate the corrected modulation phase voltage commands Vub*, Vvb*, Vwb*. In this case, the modulation voltage corrector 23 calculates the correction voltage (offset voltage VY) with β set at 0, and superimposes the correction voltage as the second common voltage on the modulation phase voltage commands Vua*, Vva*, Vwa* for the respective phases, thus performing correction.

In FIG. 11, the corrected modulation phase voltage commands Vub*, Vvb*, Vwb* and the phase currents iu, iv, iw for the respective phases are shown, and for U phase, a waveform Upb indicating whether or not the polarities of the modulation phase voltage command Vub* and the phase current iu match each other, is shown.

In a case of the modulation phase voltage command Vub*=0, Upb is considered as 1, which indicates that the polarities match each other. That is, Upb is considered as 1, as long as the polarity of the modulation phase voltage command Vub* does not become opposite to the polarity of the phase current iu.

Also in the present embodiment, the modulation phase voltage commands Vub*, Vvb*, Vwb* for the respective phases are generated by superimposing the first common voltage (offset voltage VX) and the second common voltage (offset voltage VY) which are common among the phases, on the phase voltage commands Vu*, Vv*, Vw* having sinusoidal voltage waveforms. Thus, line voltages among the modulation phase voltage commands Vub*, Vvb*, Vwb* for the respective phases are kept as voltages having sinusoidal waveforms, and the load 3 is not influenced.

As shown in FIG. 11, the magnitudes (absolute values) of the modulation phase voltage commands Vub*, Vvb*, Vwb* for the respective phases are limited by the set voltage ((Vdc/2)−β). In this case, since β is 0, they are limited by the set voltage (Vdc/2).

As shown in the waveform Upb, in a period in which U phase is the middle phase, there is a section t2 where the polarity of the modulation phase voltage command Vub* and the polarity of the phase current iu are opposite to each other, and in the section t2, the modulation phase voltage command Vvb*, Vwb* for V phase or W phase is limited to the set voltage (Vdc/2). The section t2 can be significantly shortened as compared to the section t1 shown in FIG. 7. This feature applies also to V phase and W phase.

As described above, in the present embodiment, a period in which the modulation phase voltage command Vub*, Vvb*, Vwb* for each phase has a polarity opposite to the phase current iu, iv, iw for the corresponding phase can be significantly shortened, and the magnitudes of the modulation phase voltage commands Vub*, Vvb*, Vwb* can be always reduced to (Vdc/2) or less.

Thus, as in the above embodiment 1, the numbers of times of switching of the second switching elements (Q2u, Q3u), (Q2v, Q3v), (Q2w, Q3w) connected to the AC terminals for the respective phases can be significantly decreased, whereby switching loss can be significantly reduced. Therefore, unevenness of loss among a plurality of switching elements for the respective phases of the NPC inverter 10 can be suppressed, thus obtaining the power conversion device 1 having high output and high efficiency.

Further, since the magnitudes of the modulation phase voltage commands Vua*, Vva*, Vwa* can be always reduced to (Vdc/2) or less, occurrence of overmodulation in PWM control can be prevented, so that distortion of output voltage and current is suppressed and reliability of control is improved.

In the above embodiment 2, the modulation voltage corrector 23 searches for two phases, i.e., the maximum phase and the minimum phase, to calculate the offset voltage VY. However, the modulation voltage corrector 23 may search for one phase in which a magnitude (absolute value) is greatest among the modulation phase voltage commands Vua*, Vva*, Vwa* for the respective phases. In this case, the offset voltage VY is calculated so that the magnitude (absolute value) of the modulation phase voltage command for the found one phase does not become greater than the set voltage ((Vdc/2)−β), whereby the same result as in the above embodiment 2 is obtained.

### Embodiment 3

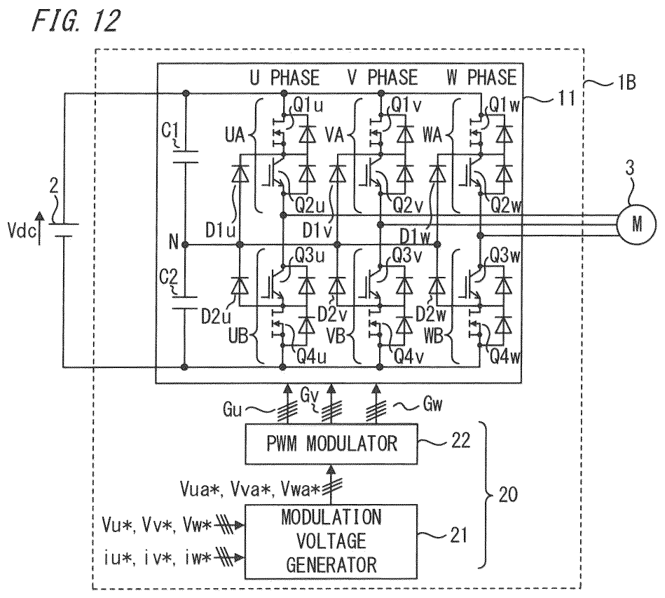

FIG. 12 is a configuration diagram showing a power conversion device according to embodiment 3.

As shown in FIG. 12, a power conversion device 1B includes an NPC inverter 11 as a three-phase three-level power converter, and the control device 20 which performs output control for the NPC inverter 11 through PWM control. The power conversion device 1B is, for example, connected between the DC power supply 2 and the motor which is the load 3, and converts DC power of the DC power supply 2 to AC power, to supply the AC power to the load 3. In this case, the NPC inverter 11 is the same as that in the above embodiment 1 except for the element configurations of the switching elements Q1u to Q4u, Q1v to Q4v, Q1w to Q4w, and the control device 20 is also the same as that in the above embodiment 1.

The first switching elements (switching elements Q1u, Q1v, Q1w) in the upper arms UA, VA, WA for the respective phases of the NPC inverter 11 are connected to the DC terminal on the high-voltage side, and the second switching elements (switching elements Q2u, Q2v, Q2w) are connected to the AC terminals for the respective phases. The first switching elements (switching elements Q4u, Q4v, Q4w) in the lower arms UB, VB, WB for the respective phases are connected to the DC terminal on the low-voltage side, and the second switching elements (switching elements Q3u, Q3v, Q3w) are connected to the AC terminals for the respective phases. The clamp diodes D1u, D1v, D1w connected to the upper arms UA, VA, WA have anodes connected to the neutral point N. The clamp diodes D2u, D2v, D2w connected to the lower arms UB, VB, WB have cathodes connected to the neutral point N.

In the present embodiment, different switching elements are used for the first switching element (Q1u, Q1v, Q1w), (Q4u, Q4v, Q4w) and the second switching element (Q2u, Q2v, Q2w), (Q3u, Q4v, Q4w) in each of the upper and lower arms of the NPC inverter 11. Hereinafter, the first switching elements (Q1u, Q1v, Q1w) are referred to as first switching elements Q1, and the first switching elements (Q4u, Q4v, Q4w) are referred to as first switching elements Q4. Similarly, the second switching elements (Q2u, Q2v, Q2) are referred to as second switching elements Q2, and the second switching elements (Q3u, Q3v, Q3w) are referred to as second switching elements Q3.

For the first switching elements Q1, Q4, elements in which switching loss is smaller are used as compared to the second switching elements Q2, Q3. Meanwhile, for the second switching elements Q2, Q3, elements in which conduction loss due to the ON resistance is smaller are used as compared to the first switching elements Q1, Q4.

In this case, MOSFETs made of SiC (silicon carbide), which can achieve small switching loss, are used for the first switching elements Q1, Q4. In addition, IGBTs made of silicon, which can achieve small conduction loss even when large current flows, are used for the second switching elements Q2, Q3.

As described in the above embodiment 1, the control device 20 generates the modulation phase voltage commands Vua*, Vva*, Vwa* such that each polarity thereof does not become opposite to the polarity of the corresponding phase current command iu*, iv*, iw*, to perform PWM control for the NPC inverter 11. Therefore, for the second switching elements Q2, Q3, the numbers of times of switching can be significantly decreased but the conduction periods become long.

Power loss in each of the first and second switching elements (Q1, Q4), (Q2, Q3) can be represented by the sum of switching loss and conduction loss.

In the present embodiment, elements in which switching loss is small are used for the first switching elements Q1, Q4 for which the numbers of times of switching are large, and elements in which conduction loss due to the ON resistance is small are used for the second switching elements Q2, Q3 for which the numbers of times of switching are significantly decreased but the conduction periods are long. Thus, power loss in each of the first and second switching elements (Q1, Q4), (Q2, Q3) can be effectively reduced and loss reduction in the entire NPC inverter 11 can be achieved, so that the power conversion device 1B having high efficiency is obtained.

The first switching elements Q1, Q4 are not limited to MOSFETs made of SiC and may be MOSFETs made of a semiconductor material having a wider bandgap than silicon, and any element in which switching loss is comparatively small may be used. Also, the second switching elements Q2, Q3 are not limited to IGBTs made of silicon, and any element in which conduction loss is comparatively small even when large current flows may be used.

In the present embodiment, as described above, the switching elements Q1u to Q4u, Q1v to Q4v, Q1w to Q4w of the NPC inverter 11 can be configured so that loss is reduced. In a case where principal control for the NPC inverter 11 is to supply power to the load 3 through power-running operation, it is possible to achieve high-efficiency power conversion operation while reducing both of conduction loss and switching loss in the switching elements Q1u to Q4u, Q1v to Q4v, Q1w to Q4w.

In particular, in a case where the load 3 is a motor for driving a propulsion fan of an aircraft, most part of operation is power-running operation and thus the effect is great. Further, since a surface-magnet-type permanent magnet motor having a high power factor is used for the motor of the load 3, a period in which the polarity of phase voltage and the polarity of phase current match each other is long. Therefore, both of conduction loss and switching loss in the switching elements Q1u to Q4u, Q1v to Q4v, Q1w to Q4w can be reduced more effectively.

In the present embodiment, the control in the above embodiment 1 is applied. However, the control in the above embodiment 2 can also be applied in the same manner, and also in this case, both of conduction loss and switching loss in the switching elements Q1u to Q4u, Q1v to Q4v, Q1w to Q4w are reduced, so that the power conversion device 1B having high efficiency is obtained.

In each of the above embodiments, the NPC inverter 10, 11 which is a three-phase three-level power converter is used as a multilevel power converter of a neutral point clamped type. However, a configuration with multiple phases more than three phases may be applied and a multilevel power converter for more than three levels may be applied.

The functions of the control device 20, 20A in each of the above embodiments are implemented by a processing circuit.

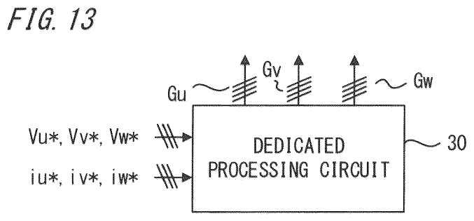

FIG. 13 is a configuration diagram showing an example of hardware for implementing the functions of the control device 20, 20A. In this case, the control device 20, 20A is configured by a dedicated processing circuit 30 which is dedicated hardware.

The dedicated processing circuit 30 is, for example, a single circuit, a complex circuit, a programmed processor, a parallel-programmed processor, an application specific integrated circuit (ASIC), a field programmable gate array (FPGA), or a combination thereof.

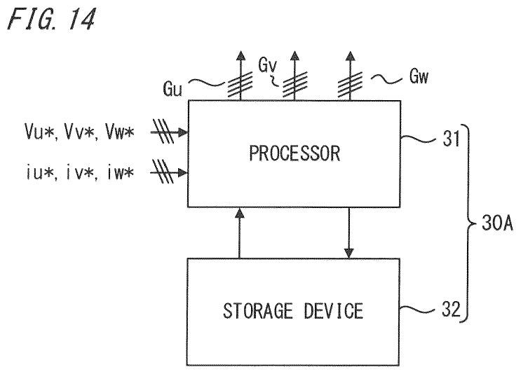

FIG. 14 is a configuration diagram showing another example of hardware for implementing the functions of the control device 20, 20A. In this case, a processing circuit 30A includes a processor 31 and a storage device 32.

In the processing circuit 30A, the functions of the control device 20, 20A are implemented by software, firmware, or a combination of software and firmware. The software and the firmware are described as a program, which is stored in the storage device 32. The processor 31 reads and executes the program stored in the storage device 32, to implement the functions.

The program stored in the storage device 32 can be considered to be a thing for causing a computer to execute the procedure or method in each unit described above. Here, the storage device 32 is, for example, a nonvolatile or volatile semiconductor memory such as a random access memory (RAM), a read only memory (ROM), a flash memory, an erasable programmable read only memory (EPROM), or an electrically erasable and programmable read only memory (EEPROM). Also, a magnetic disk, a flexible disk, an optical disc, a compact disc, a mini disc, a DVD, or the like may be used for the storage device 32.

Of the functions of the control device 20, 20A described above, some may be implemented by dedicated hardware and others may be implemented by software or firmware.

Thus, the processing circuit can implement the functions of the control device 20, 20A described above by hardware, software, firmware, or a combination thereof.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1, 1A, 1B power conversion device
10, 11 NPC inverter
20, 20A control device
21 modulation voltage generator
22 PWM modulator
23 modulation voltage corrector
24 second modulation voltage generator
Gu, Gv, Gw gate signal
N neutral point
UA, VA, WA upper arm
UB, VB, WB lower arm
Q1u, Q1v, Q1w first switching element
Q2u, Q2v, Q2w second switching element
Q3u, Q3v, Q3w second switching element
Q4u, Q4v, Q4w first switching element
Vu*, Vv*, Vw*, VA* phase voltage command
iu*, iv*, iw*, iA* phase current command
iu, iv, iw, iA phase current
Vua*, Vva*, Vwa* modulation phase voltage command
Vub*, Vvb*, Vwb* modulation phase voltage command
VX offset voltage
VY offset voltage as correction voltage

1. A power conversion device comprising:
a multilevel power converter of a neutral point clamped type, which performs power conversion between DC power and AC power; and
a control device which performs output control for the power converter through PWM control, wherein
the power converter has a multiphase configuration that includes, in each phase of the power converter, an upper arm and a lower arm each formed by connecting a first switching element on a DC terminal side and a second switching element on an AC terminal side in series to each other, and a clamp diode connected between a neutral point and a connection point between the first and second switching elements,
the control device includes a modulation voltage generator which generates modulation phase voltage commands on the basis of phase voltage commands and phase currents, and a PWM modulator which generates gate signals for driving the first and second switching elements of the power converter, on the basis of the modulation phase voltage commands, and
the modulation voltage generator calculates offset voltage so that, for a middle phase in which a high-low rank is middle among the phase voltage commands for the respective phases, a polarity of the phase voltage command does not become opposite to a polarity of the phase current, and superimposes the offset voltage as first common voltage on the phase voltage commands for the respective phases, to generate the modulation phase voltage commands.

2. The power conversion device according to claim 1, wherein
the phase voltage commands are voltage commands having sinusoidal waveforms, and
the modulation voltage generator calculates the offset voltage so that, for the middle phase, a value of the phase voltage command in a period in which the polarity of the phase voltage command is positive and the polarity of the phase current is negative does not become greater than 0, and a value of the phase voltage command in a period in which the polarity of the phase voltage command is negative and the polarity of the phase current is positive does not become smaller than 0.

3. The power conversion device according to claim 1, wherein
the modulation voltage generator performs correction by superimposing second common voltage on the modulation phase voltage commands for the respective phases so that magnitudes of the generated modulation phase voltage commands for the respective phases do not become greater than set voltage based on DC voltage on the DC terminal side.

4. The power conversion device according to claim 3, wherein
the modulation voltage generator calculates correction voltage so that, for a phase in which a magnitude is greatest among the generated modulation phase voltage commands for the respective phases, a value of the modulation phase voltage command becomes the set voltage, and superimposes the correction voltage as the second common voltage on the modulation phase voltage commands for the respective phases, to perform the correction.

5. The power conversion device according to claim 1, wherein
the control device generates the modulation phase voltage commands, using phase current commands as the phase currents.

6. The power conversion device according to claim 1, wherein
the power converter is a three-phase three-level power converter.

7. The power conversion device according to claim 1, wherein
conduction loss due to an ON resistance of the second switching element is smaller than conduction loss due to an ON resistance of the first switching element.

8. The power conversion device according to claim 1, wherein
switching loss in the first switching element is smaller than switching loss in the second switching element.

9. The power conversion device according to claim 1, wherein
an IGBT made of silicon is used for the second switching element.

10. The power conversion device according to claim 1, wherein
a MOSFET made of a semiconductor material having a wider bandgap than silicon is used for the first switching element.

11. The power conversion device according to claim 2, wherein
the modulation voltage generator performs correction by superimposing second common voltage on the modulation phase voltage commands for the respective phases so that magnitudes of the generated modulation phase voltage commands for the respective phases do not become greater than set voltage based on DC voltage on the DC terminal side.

12. The power conversion device according to claim 11, wherein
the modulation voltage generator calculates correction voltage so that, for a phase in which a magnitude is greatest among the generated modulation phase voltage commands for the respective phases, a value of the modulation phase voltage command becomes the set voltage, and superimposes the correction voltage as the second common voltage on the modulation phase voltage commands for the respective phases, to perform the correction.

13. The power conversion device according to claim 2, wherein
the control device generates the modulation phase voltage commands, using phase current commands as the phase currents.

14. The power conversion device according to claim 3, wherein
the control device generates the modulation phase voltage commands, using phase current commands as the phase currents.

15. The power conversion device according to claim 4, wherein
the control device generates the modulation phase voltage commands, using phase current commands as the phase currents.

16. The power conversion device according to claim 2, wherein
the power converter is a three-phase three-level power converter.

17. The power conversion device according to claim 2, wherein
conduction loss due to an ON resistance of the second switching element is smaller than conduction loss due to an ON resistance of the first switching element.

18. The power conversion device according to claim 2, wherein
switching loss in the first switching element is smaller than switching loss in the second switching element.

19. The power conversion device according to claim 2, wherein
an IGBT made of silicon is used for the second switching element.

20. The power conversion device according to claim 2, wherein
a MOSFET made of a semiconductor material having a wider bandgap than silicon is used for the first switching element.
